(19) United States
(12) Patent Application Publication
(10) Pub. No.: US 2015/0208094 A1
(43) Pub. Date: Jul. 23, 2015

(54) APPARATUS AND METHOD FOR DETERMINING DCT SIZE BASED ON TRANSFORM DEPTH

(71) Applicant: ELECTRONICS AND TELECOMMUNICATIONS RESEARCH INSTITUTE, Daejeon (KR)

(72) Inventors: Suk-Ho LEE, Daejeon (KR); Kyung-Jin BYUN, Daejeon (KR); Nak-Woong EUM, Daejeon (KR)

(73) Assignee: ELECTRONICS AND TELECOMMUNICATIONS RESEARCH INSTITUTE, Daejeon (KR)

(21) Appl. No.: 14/598,253

(22) Filed: Jan. 16, 2015

(30) Foreign Application Priority Data
Jan. 20, 2014 (KR) 10-2014-0006860

(51) Int. Cl. H04N 19/625; H04N 19/61; H04N 19/96

(52) U.S. Cl. CPC H04N 19/625; H04N 19/96; H04N 19/61

(57) ABSTRACT

An apparatus and method for determining a discrete cosine transform (DCT) size based on a transform depth are disclosed herein. The apparatus for determining a DCT size based on a transform depth includes a prediction mode determination unit, a transform unit (TU) generation unit, and a DCT performance unit. The prediction mode determination unit determines a prediction mode in order to determine a DCT size at the root location of a coding unit (CU) present in a coding tree unit (CTU). The transform unit (TU) generation unit partitions the CU into transform units (TUs) based on a residual quad tree (RQT). The DCT performance unit performs a DCT based on the TUs.

### CROSS-REFERENCE TO RELATED APPLICATION

This application claims the benefit of Korean Patent Application No. 10-2014-0006860, filed Jan. 20, 2014, which is hereby incorporated by reference herein in its entirety.

### BACKGROUND

1. Technical Field

The present invention relates generally to an apparatus and method for determining a discrete cosine transform (DCT) size based on a transform depth and, more particularly, to an apparatus and method for determining a DCT size based on a transform depth, which are capable of determining a DCT size in an early stage based on various discrete cosine transform (DCT) depths in order to increase the speed of an encoder, which is a technology that is used in a High Efficiency Video Coding (HEVC) apparatus that is a next-generation video codec.

2. Description of the Related Art

In a video encoder, a transform is performed on the resulting values of a residual sample with respect to an original image after image prediction in various modes (e.g., an intra-prediction mode and an inter-prediction mode) has been performed. In general, an integer multiplication transform or a DCT is employed due to the characteristics of images.

In the H.264 standard, a 4×4 or 8×8 integer multiplication transform is used, and the resulting coefficients of the transform of a residual sample are distributed in portions having higher similarity with each of 16 or 64 different filters. Due to the characteristics of images in the natural world, most coefficients gather in a direct current (DC), i.e., the first block (0,0) of a transform, and the remaining parts are discarded through a quantization process. As a result, the bit rate of an encoded image is reduced.

In the H.264 standard, each block is partitioned into 4×4 small sub-blocks with respect to the luma signal of a 16×16 macro block, and a 4×4 orthogonal transform is performed only on the 4×4 small sub-blocks. Furthermore, an 8×8 orthogonal transform is performed with respect to an 8×8 intra-prediction mode.

In contrast, in an HEVC standard having a 50% or more improved compression ratio, a DCT is performed on a maximum coding unit (CU) size at the root location of a CU that is present within a coding tree unit (CTU). A DCT size based on a transform depth is finally determined by repeatedly performing 32×32, 16×16, 8×8 and 4×4 DCT based on a residual quad tree (RQT).

A decoder receives transform information, and simply performs inverse DCT (IDCT) with respect to a predetermined mode. In contrast, an encoder sequentially or simultaneously performs a transform on all the DCT sizes within a CU, performs rate distortion optimization (RDO) on the results of the transform, and finally selects a DCT size having the lowest bit occurrence rate.

The above method is advantageous in that it can increase a compression ratio. However, this method has problems in that high computational load is incurred and resources required for implementation are relatively increased. Accordingly, there is a need for an apparatus and method for determining a DCT size based on a transform depth, which determine a DCT size in an early stage based on various DCT depths in order to increase the speed of an encoder, which is a technology used in an HEVC coding apparatus that is a next-generation video codec adopted as a standard subsequent to the current H.264 standard. A related art includes Korean Patent Application Publication No. 2013-0079090.

### SUMMARY

At least one embodiment of the present invention is directed to enabling the reduction of the time required for coding and HW/SW resources required for the implementation of the coding by previously determining a DCT size based on a transform depth using a motion vector (MV) and the previously calculated intra or inter sum-of-absolute differences (SAD) of a prediction block (PU) forming a CU in the performance of DCT.

In accordance with an aspect of the present invention, there is provided an apparatus for determining a discrete cosine transform (DCT) size based on a transform depth, the apparatus including a prediction mode determination unit configured to determine a prediction mode in order to determine a DCT size at the root location of a coding unit (CU) present in a coding tree unit (CTU); a transform unit (TU) generation unit configured to partition the CU into transform units (TUs) based on a residual quad tree (RQT); and a DCT performance unit configured to perform a DCT based on the TUs.

The prediction mode determination unit may be further configured to determine any one of an intra-prediction mode and an inter-prediction mode depending on the similarity between a predicted image and an original image.

The DCT performance unit may include a first SAD value calculation unit configured to calculate a first SAD value that is an SAD value corresponding to the RQT, with respect to the SAD value of the TUs corresponding to the prediction mode determined by the prediction mode determination unit.

The DCT performance unit may include a second SAD value calculation unit configured to calculate a second SAD value that is the SAD value of a candidate prediction block corresponding to the predicted image.

The DCT performance unit may further include a variance value calculation unit configured to calculate a variance value within a quad tree based on the difference between the first SAD value and the second SAD value.

The DCT performance unit may further include a comparison unit configured to compare the variance value with a predetermined threshold range.

The DCT performance unit may further include a size determination unit configured to increase a DCT depth and then perform a DCT having a smaller size if the variance value exceeds the predetermined threshold range and to determine a current DCT size to be a final size if the variance value does not exceed the predetermined threshold range.

The DCT performance unit may be further configured to determine whether a mode is a skip mode or an inter-prediction mode in which a motion vector is zero and to perform a DCT using a DCT size corresponding to that in a previous image if, as a result of the determination, it is determined that the mode is the skip mode or the inter-prediction mode in which a motion vector is zero and also a size of the CU is equal to that in the previous image.

The DCT performance unit may be further configured to determine whether a mode is a skip mode or an inter-prediction mode in which a motion vector is zero and to determine a DCT size by repeating the DCT until the variance value does not exceed a determined threshold range if, as a result of the determination, it is determined that the mode is not the skip mode or the inter-prediction mode in which a motion vector is zero.

The DCT performance unit may be further configured to determine whether a mode is a skip mode or an inter-prediction mode in which a motion vector is zero and to determine a DCT size by repeating the DCT until the variance value does not exceed the determined threshold range if, as a result of the determination, it is determined the mode is the skip mode or the inter-prediction mode in which a motion vector is zero and also it is determined that the size of the CU is not equal to that in the previous image.

In accordance with another aspect of the present invention, there is provided a method of determining a discrete cosine transform (DCT) size based on a transform depth, the method including a prediction mode determination step of determining, by a prediction mode determination unit, a prediction mode in order to determine a DCT size at a root location of a coding unit (CU) present in a coding tree unit (CTU); a transform unit (TU) generation step of partitioning, by a TU generation unit, the CU into transform units (TUs) based on a residual quad tree (RQT); and a DCT performance step of performing, by a DCT performance unit, DCT based on the TUs.

The prediction mode determination step may include determining any one of an intra-prediction mode and an inter-prediction mode depending on a similarity between a predicted image and an original image.

The DCT performance step may include calculating a first SAD value that is an SAD value corresponding to the RQT, with respect to an SAD value of the TU corresponding to a prediction mode determined at the prediction mode determination step.

The DCT performance step may include calculating a second SAD value which is an SAD value of a candidate prediction block corresponding to the predicted image after calculating the first SAD value.

The DCT performance step may include calculating a variance value within a quad tree based on the difference between the first SAD value and the second SAD value after calculating the second SAD value.

The DCT performance step may include comparing the variance value with a predetermined threshold range after calculating the variance value.

The DCT performance step may include increasing a DCT depth and performing DCT having a smaller size if the variance value exceeds the predetermined threshold range; and determining a current DCT size to be a final size if the variance value does not exceed the predetermined threshold range.

The DCT performance step may include determining whether a mode is a skip mode or an inter-prediction mode in which a motion vector is zero; and performing DCT using a DCT size corresponding to that in a previous image if, as a result of the determination, it is determined that the mode is the skip mode or the inter-prediction mode in which a motion vector is zero and also if a size of the CU is equal to that in the previous image.

The DCT performance step may include determining whether a mode is a skip mode or an inter-prediction mode in which a motion vector is zero; and determining a DCT size by repeating the DCT until the variance value does not exceed a determined threshold range if, as a result of the determination, it is determined that the mode is not the skip mode or the inter-prediction mode in which a motion vector is zero.

The DCT performance step may include determining whether a mode is a skip mode or an inter-prediction mode in which a motion vector is zero; and determining a DCT size by repeating the DCT until the variance value does not exceed the determined threshold range if, as a result of the determination, it is determined that the mode is the skip mode or the inter-prediction mode in which a motion vector is zero and it is determined that the size of the CU is not equal to that in the previous image.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the structure of a quad tree in which an HEVC CU has been partitioned into units having specific sizes;

FIG. 2 is a block diagram of an apparatus for determining a DCT size based on a transform depth according to the present invention;

FIG. 3 is a diagram illustrating the DCT performance unit of the apparatus for determining a DCT size based on a transform depth according to the present invention;

FIGS. 4 to 8 are diagrams illustrating embodiments of a DCT performance unit;

FIG. 9 is a diagram illustrating an embodiment of the apparatus for determining a DCT size based on a transform depth;

FIG. 10 is a flowchart illustrating a method of determining a DCT size based on a transform depth according to the present invention; and

FIG. 11 is a diagram illustrating an embodiment of the method of determining a DCT size based on a transform depth.

### DETAILED DESCRIPTION

The present invention may be modified in various ways, and may have various embodiments. Although specific embodiments are illustrated in the drawings and described in detail, it should be understood that the present invention is not limited to the specific embodiments but includes all modifications, equivalents, and substitutions that fall within the spirit and technical scope of the present invention. Like reference numerals are used to designate like elements throughout the accompanying drawings.

The terms “first,” “second,” etc. may be used to describe various elements, but these elements should not be restricted by the terms. The terms are used merely to distinguish one element from the other element. For example, a first element may be named a second element without departing from the scope of the present invention. Likewise, a second element may be named a first element. The term “and/or” includes a combination of a plurality of related and described items or any one of a plurality of related and described items.

When it is said that one element is “connected” or “coupled” with another element, it should be understood that the one element may be directly connected or coupled with the other element, but a third element may be present between the two elements. In contrast, when it is said that one element is “directly connected” or “directly coupled” with another element, it should be understood that a third element is not present between the two elements.

The terms used herein are used merely to describe specific embodiments, and are not intended to limit the present invention. A singular expression includes a plural expression unless it is clearly described in the context. In the present application, it should be appreciated that the term “include(s)” or “have (has)” is intended to mean the presence of characteristics, numbers, steps, operations, elements, parts, or combinations thereof described in the present specification, but is not intended to exclude the possibility of presence or addition of one or more other characteristics or numbers, steps, operations, elements, parts, or combinations thereof.

Embodiments of the present invention are described in greater detail below with reference to the accompanying drawings. The same reference numerals are used to designate the same elements throughout the drawings, and redundant descriptions of the same elements are omitted.

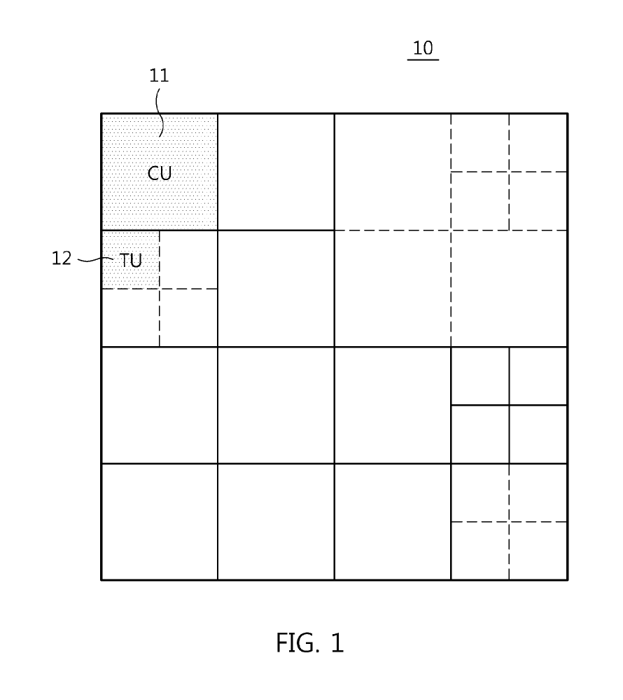

FIG. 1 is a diagram illustrating the structure of a quad tree in which an HEVC CU is partitioned into specific sizes.

Referring to FIG. 1, an outside portion indicated by thick outside solid lines is a coding tree unit (CTU) 10. The CTU 10 is divided by solid lines into coding units (CUs) 11 each having a quad tree form. A CU on which prediction has been performed is partitioned into transform units (TUs) based on a residual quad tree (RQT). A DCT is performed based on the size of the TUs.

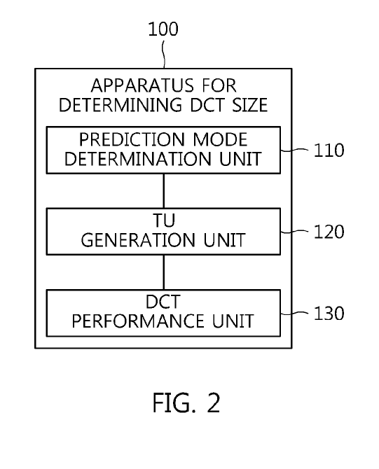

FIG. 2 is a block diagram of an apparatus 100 for determining a DCT size based on a transform depth according to the present invention.

Referring to FIG. 2, the apparatus 100 for determining a DCT size based on a transform depth according to the present invention includes a prediction mode determination unit 110, a TU generation unit 120, and a DCT performance unit 130.

The elements depicted in FIG. 2 are illustrated as being independent in order to represent the different and characteristic functions of an image coding apparatus. This does not mean that each of the elements should be a separate hardware unit or a single software unit. That is, these elements have been illustrated as separate elements for convenience of description. Accordingly, at least two elements may be combined into a single element, or a single element may be divided into a plurality of elements and perform functionality. Furthermore, an embodiment in which two or more elements have been combined into a single element and an embodiment in which a single element has been divided into a plurality of elements fall within the scope of the present invention unless they deviate from the gist of the present invention.

Furthermore, some element may not be an essential element for performing an essential function, but may be an optional element merely for improving performance. The present invention may be implemented using only elements essential to implement the gist of the present invention other than elements necessary merely to improve performance. A configuration including only essential elements other than optional elements used merely to improve performance falls within the scope of the present invention.

The elements of the apparatus 100 according to the present invention are described in greater detail.

The prediction mode determination unit 110 functions to determine a prediction mode in order to determine a DCT size at the root location of a CU that is present inside a CTU. The TU generation unit 120 functions to partition the CU into TUs based on an RQT. The DCT performance unit 130 functions to perform a DCT based on the size of the TUs.

In this case, the prediction mode determination unit 110 may determine any one of an intra-prediction mode and an inter-prediction mode depending on the similarity between a predicted image and an original image.

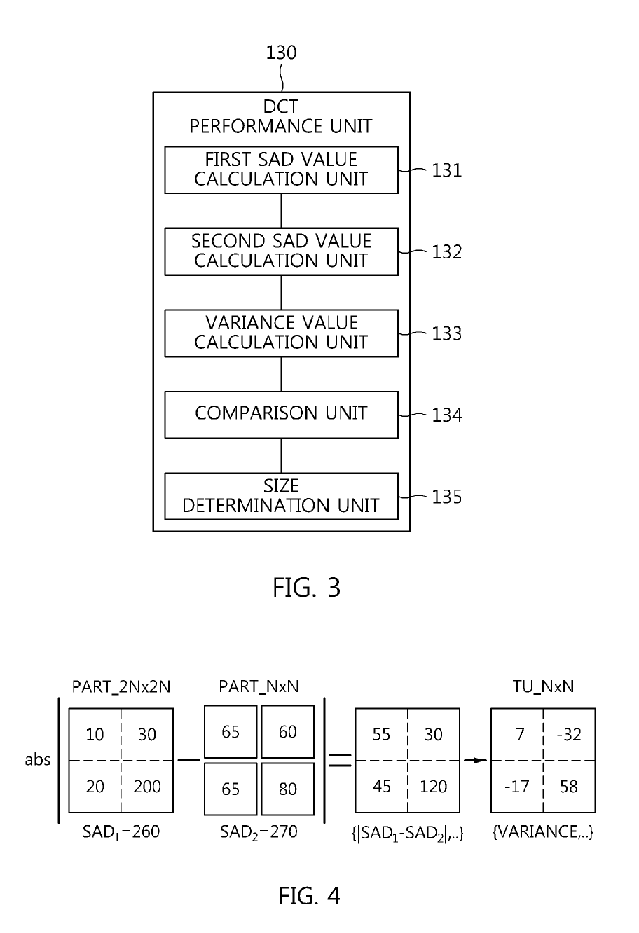

FIG. 3 is a diagram illustrating the DCT performance unit 130 of the apparatus for determining a DCT size based on a transform depth according to the present invention.

Referring to FIG. 3, the DCT performance unit 130 of the apparatus 100 according to the present invention may include a first SAD value calculation unit 131, a second SAD value calculation unit 132, a variance value calculation unit 133, a comparison unit 134, and a size determination unit 135.

More specifically, the first SAD value calculation unit 131 functions to calculate a first SAD value, that is, an SAD value corresponding to an RQT, with respect to the SAD value of TUs corresponding to a prediction mode determined by the prediction mode determination unit.

The second SAD value calculation unit 132 functions to calculate a second SAD value, that is, the SAD value of a candidate prediction block corresponding to a predicted image. The variance value calculation unit 133 functions to calculate a variance value within a quad tree based on the difference between the first SAD value and the second SAD value. The comparison unit 134 functions to compare the variance value with a predetermined threshold range. If the variance value exceeds the predetermined threshold range, the size determination unit 135 functions to increase a DCT depth and then perform a DCT having a smaller size. If the variance value does not exceed the predetermined threshold range, the size determination unit 135 functions to determine the current DCT size to be a final size.

FIGS. 4 to 8 are diagrams illustrating embodiments of a DCT performance unit.

Continuing with FIG. 1, although a TU depth of 2 levels is present, a transform depth of a maximum of 3 levels (4×4 DCT) is present in HEVC. An encoder performs DCT on all the different sizes based on an RQT within a CU, determines a mode having the smallest bit occurrence rate, and then determines a transform depth and size.

This method relatively increases the time it takes to determine a transform size due to its high computational load, thereby making it difficult to implement a real-time encoder. In the present invention, the computational load necessary for coding and required HW/SW resources are reduced by determining a transform depth and size in an early stage using an SAD and an MV required for intra/inter mode prediction that are calculated prior to a transform stage.

A CU is formed of a prediction unit (PU), and is selected as an intra PU or an inter PU depending on the similarity between a predicted image and an original image.

In general, in order to determine an intra PU or an inter PU, an SAD is calculated, and a mode having a smaller difference is determined to be a prediction mode. Unlike in the H.264 standard, if the size of a PU based on a CU increases, the distribution of SAD values having larger values (a case where the difference between a predicted image and an original image is large) within a CU block is concentrated in a specific quad block within a PART_{—}2N×2N block and the sum SAD₁ of SADs is equalized, and thus image quality (i.e., PSNR) is reduced even when the sum SAD₁ is smaller than the sum SAD₂ of SADs within a PART_N×N block, in HEVC, as illustrated in FIG. 4.

In order to improve image quality by compensating for the above problem, a transform depth may be increased even when a bit occurrence rate is increased, and quantization may be performed via DCT having a smaller size. In the present invention, SAD values in an intra/inter-prediction mode that have been determined to be a PART_{—}2N×2N block in which a PU is of a symmetrical type, as illustrated in FIG. 4, are rearranged as SAD values in a quad tree form and then calculated. An SAD is calculated with respect to the coefficients of the SAD values in a quad tree form and a group of SAD candidates within the PART_N×N block, that is, prediction candidates, as in Equation 1:

Uₙ=abs(Sₙ−Tₙ)(n=1,2,3,4) (1)

where Sₙ is a first SAD value, and Tₙ is a second SAD value. That is, an SAD may be obtained in such a way that the first SAD value calculation unit 131 calculates the first SAD value Sₙ and the second SAD value calculation unit 132 calculates the second SAD value Tₙ.

Furthermore, a variance value is calculated using Equation 2 below based on the SAD obtained using Equation 1:

Vₙ=Uₙ−Mean(n=1,2,3,4), where Mean=(U₁+U₂+U₃+U₄)>>2 (2)

In Equation 2, Vₙ is the variance value, which is calculated by the variance value calculation unit 133.

Furthermore, the comparison unit 134 determines whether the variance value Vₙ satisfies a threshold range, as in Equation 3 below:

If V_{MIN}<{All,V₁,V₂,V₃,V₄}<V_{MAX}(n=1,2,3,4)

{2N×2N transform depth decision→Termination}

Else

{N×N transform} (3)

More specifically, if a variance value within a quad tree exceeds a threshold range, as in Equation 3, the DCT performance unit 130 increases a DCT depth and then performs DCT having a smaller size. If a variance value within a quad tree does not exceed a threshold range, as in Equation 3, the DCT performance unit 130 determines a current transform size in an early stage and determines a TU size within a specific CU in an early stage.

Furthermore, the DCT performance unit 130 may determine whether a mode is a skip mode or an inter-prediction mode in which a motion vector is zero. If, as a result of the determination, it is determined that the mode is a skip mode or an inter-prediction mode, the DCT performance unit 130 may use a DCT size corresponding to that of the previous image if the size of a CU is the same as that in a previous image.

Furthermore, the DCT performance unit 130 may determine whether a mode is a skip mode or an inter-prediction mode in which a motion vector is zero. If, as a result of the determination, it is determined that the mode is not a skip mode or an inter-prediction mode, the DCT performance unit 130 may determine a DCT size by repeatedly performing DCT until the variance value does not exceed the predetermined threshold range.

Furthermore, the DCT performance unit 130 may determine whether a mode is a skip mode or an inter-prediction mode in which a motion vector is zero. If, as a result of the determination, it is determined that the mode is a skip mode or an inter-prediction mode, the DCT performance unit 130 may determine a DCT size by repeatedly DCT until the variance value does not exceed the predetermined threshold range if the size of a CU is not the same as that in a previous image.

More specifically, continuing with FIG. 4, an example in which the SAD values SAD₁ in the PART_{—}2N×2N block are distributed in a specific region of a quad tree, as described above, is illustrated.

In this case, if the degree of a calculated variance exceeds a specific range, a transform depth is increased and then DCT having a smaller size is performed.

Such calculation continues to be performed until DCT having a 4×4 size has been reached in the case of inter-prediction and until DCT having an 8×8 size has been reached in the case of intra-prediction. FIG. 6 is an example in which the SAD values SAD₁ in the PART_{—}2N×2N block are distributed across all the regions of the quad tree. In this case, since the degree of a calculated variance is present in a specific range, a 2N×2N DCT is performed, and then the DCT is early terminated.

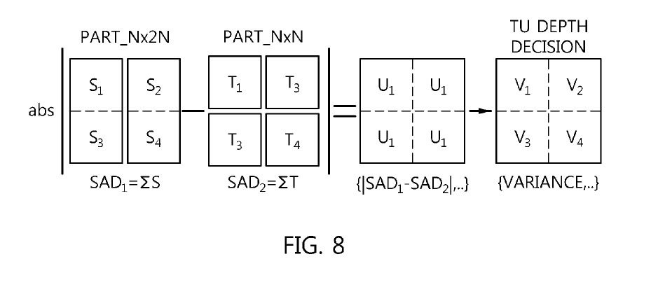

A case where an inter-prediction unit is an asymmetrical PART_N×2N unit and a case where an inter-prediction unit is an asymmetrical PART_{—}2N×N unit are illustrated in FIGS. 7 and 8, respectively. In these cases, asymmetrical PUs are arranged as a group of SAD values having a quad tree form like the symmetrical PUs, a variance value is calculated using Equations 1 to 3, and a transform depth is determined based on the variance value.

In a skip mode or an inter-prediction mode in which a motion vector is zero (0), if the size of a CU is the same as that in a previous image, this corresponds to a case where there is almost no change in an image. Accordingly, a transform depth and size that are the same as those in a previous image are used, and a frame difference-related variance value used to determine the transform depth and size is not calculated.

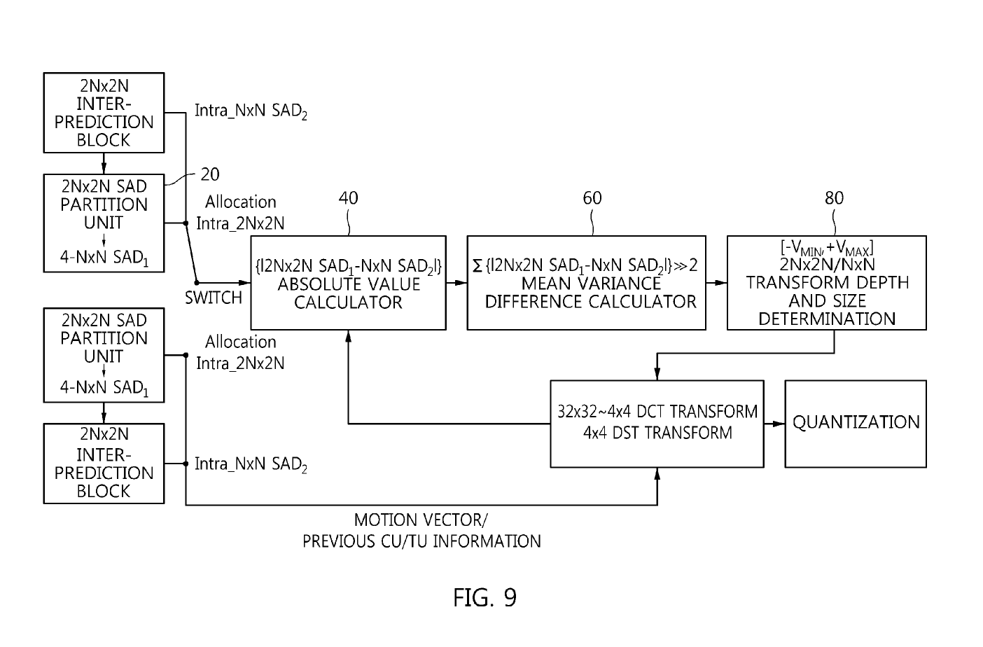

FIG. 9 is a diagram illustrating an embodiment of the apparatus for determining a DCT size based on a transform depth according to the present invention.

The embodiment of the apparatus for determining a DCT size based on a transform depth according to the present invention is described below with reference to FIG. 9. A 2N×2N SAD partition unit 20 rearranges SAD values into 4 groups based on the regions of a quad tree, and calculates the SAD value of each of the regions. Furthermore, an absolute value calculator 40 calculates absolute differences using SAD1 values calculated in a previous SAD partition block and the SAD2 values of an intra/inter N×N block as its inputs. A mean variance difference calculator 60 calculates the mean of the absolute values of the received SAD1 and SAD2 values, and calculates the variance values of the four blocks of the quad tree using the mean. If the variance values of a previous block fall within a threshold range, a transform depth and size determination block 80 determines a size based on a current DCT depth in an early stage and performs quantization. If the variance values of the previous block exceeds the threshold range, the transform depth and size determination block 80 increases a transform depth (or decreases a DCT size), and the absolute value calculator 40 repeats the same calculation. If a coding block is an inter-prediction block, a motion vector is zero and the size of a CU is the same as that at the same location of a previous image, DCT is completed using information about a previous transform depth (i.e., a TU depth) without calculating a variance value based on SADs used to calculate a transform depth.

A method of determining a DCT size based on a transform depth according to the present invention is described below. As described above, redundant descriptions of technical features that overlap those of the apparatus for determining a DCT size based on a transform depth according to the embodiment of the present invention are omitted.

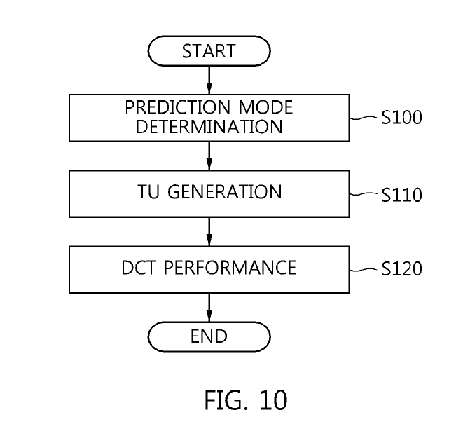

FIG. 10 is a flowchart illustrating the method of determining a DCT size based on a transform depth according to the present invention.

Referring to FIG. 10, the method of determining a DCT size based on a transform depth according to the present invention includes a prediction mode determination step S100, a TU generation step S110, and a DCT performance step S120.

More specifically, in the method of determining a DCT size based on a transform depth according to the present invention, the prediction mode determination unit 110 performs the prediction mode determination step S100 of determining a prediction mode in order to determine a DCT size at the root location of a CU within a CTU.

After the prediction mode determination step S100 has been performed, the TU generation unit 120 performs the TU generation step S110 of partitioning the CU into TUs based on an RQT. After the TU generation step S110 has been performed, the DCT performance unit 130 performs the DCT performance step S120 of performing DCT based on the size of the TU.

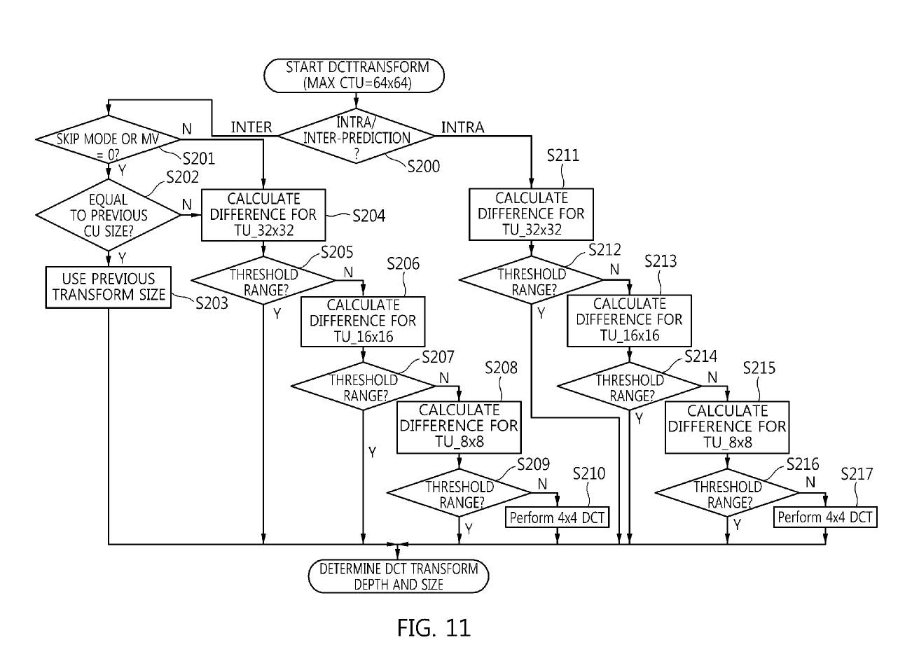

FIG. 11 is a diagram illustrating an embodiment of the method of determining a DCT size based on a transform depth.

The embodiment of the method of determining a DCT size based on a transform depth according to the present invention is described below with reference to FIG. 11. In the case where a maximum CTU size is 64×64, when DCT starts, whether a mode is an intra or inter-prediction mode is determined at step S200. If, as a result of the determination, it is determined that the mode is an inter-prediction mode, whether the inter-prediction mode corresponds to a skip mode or a motion vector is zero (0) is determined at step S201.

If, as a result of the determination, it is determined that the inter-prediction mode corresponds to a skip mode or the motion vector is zero (0), whether coding has been performed using a CU having the same size as that in a previous image is determined at step S202. If, as a result of the determination, it is determined that the coding has been performed using the CU having the same size as that in the previous image, a DCT size used in the previous image is used in accordance with a quad tree without calculating differences in order to determine a transform size at step S203.

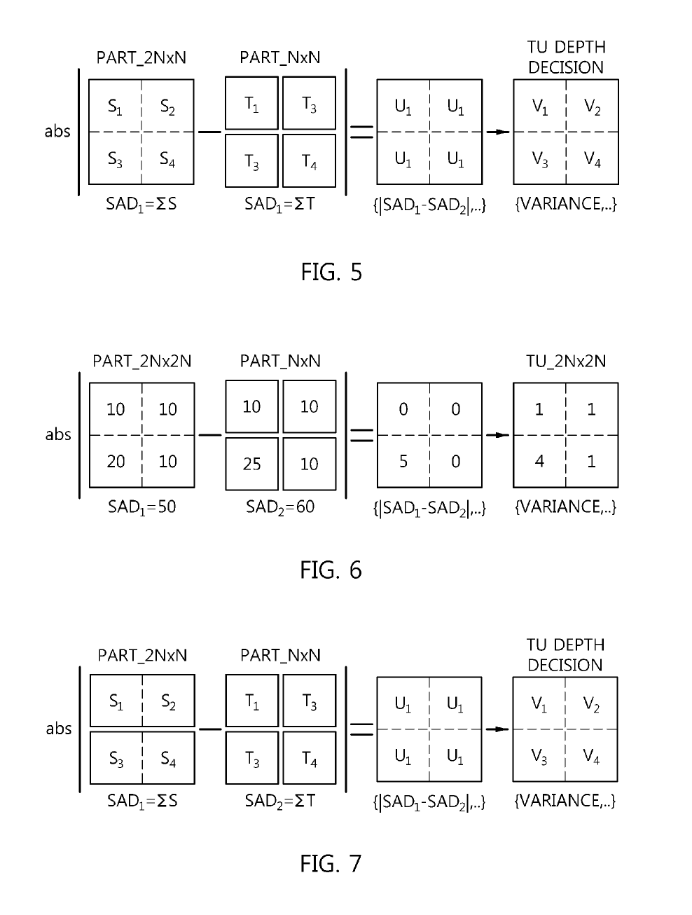

If, as a result of the determination, it is determined that the current size of the CU is not the same as that of the previous image, inter PART_{—}32×32 SAD values used for frame prediction are rearranged in accordance with a quad tree using Equations 1 to 3, as illustrated in FIG. 5, and inter PART_{—}16×16 SAD values and a variation based on the SAD values are calculated at step S204. In this case, whether all the finally calculated variance values V1, V2, V3 and V4 are present within a threshold range [−VMIN, +VMAX] is determined at steps S205 to S209. If, as a result of the determination, it is determined that all the finally calculated variance values V1, V2, V3, and V4 are present within the threshold range [−VMIN, +VMAX], the size of DCT is determined to be 32×32, that is, a current prediction size, and then the DCT is terminated.

If the DCT is not terminated in an early stage, the calculation may continue to be performed up to the DCT depth of a 4×4 size at steps S206 to S210 in the case of the inter-prediction mode, and may continue to be performed up to the DCT depth of an 8×8 size at steps S211 to S217 in the case of the intra-prediction mode.

As described above, the apparatus and method for determining a DCT size based on a transform depth according to the present invention are advantageous in that a DCT size based on a transform depth is determined in an early stage based on an SAD used in a PU and then quantized, so that a real-time encoder can be implemented because computational load is reduced and also power consumption can be reduced because a small number of HW/SW resources are used.

As described above, the apparatus and method for determining a DCT size based on a transform depth according to the present invention are not limited to the configurations and methods of the described embodiments, and all or some of the embodiments may be selectively combined so that the embodiments are modified or varied in various ways.

What is claimed is:

1. An apparatus for determining a discrete cosine transform (DCT) size based on a transform depth, the apparatus comprising:
a prediction mode determination unit configured to determine a prediction mode in order to determine a DCT size at a root location of a coding unit (CU) present in a coding tree unit (CTU);
a transform unit (TU) generation unit configured to partition the CU into transform units (TUs) based on a residual quad tree (RQT); and
a DCT performance unit configured to perform a DCT based on the TUs.

2. The apparatus of claim 1, wherein the prediction mode determination unit is further configured to determine any one of an intra-prediction mode and an inter-prediction mode depending on similarity between a predicted image and an original image.

3. The apparatus of claim 2, wherein the DCT performance unit comprises a first SAD value calculation unit configured to calculate a first SAD value that is an SAD value corresponding to the RQT, with respect to an SAD value of the TUs corresponding to the prediction mode determined by the prediction mode determination unit.

4. The apparatus of claim 3, wherein the DCT performance unit comprises a second SAD value calculation unit configured to calculate a second SAD value that is an SAD value of a candidate prediction block corresponding to the predicted image.

5. The apparatus of claim 4, wherein the DCT performance unit further comprises a variance value calculation unit configured to calculate a variance value within a quad tree based on a difference between the first SAD value and the second SAD value.

6. The apparatus of claim 5, wherein the DCT performance unit further comprises a comparison unit configured to compare the variance value with a predetermined threshold range.

7. The apparatus of claim 6, wherein the DCT performance unit further comprises a size determination unit configured to increase a DCT depth and then perform a DCT having a smaller size if the variance value exceeds the predetermined threshold range and to determine a current DCT size to be a final size if the variance value does not exceed the predetermined threshold range.

8. The apparatus of claim 1, wherein the DCT performance unit is further configured to:
determine whether a mode is a skip mode or an inter-prediction mode in which a motion vector is zero; and
perform a DCT using a DCT size corresponding to that in a previous image if, as a result of the determination, it is determined that the mode is the skip mode or the inter-prediction mode in which a motion vector is zero and also a size of the CU is equal to that in the previous image.

9. The apparatus of claim 8, wherein the DCT performance unit is further configured to:
determine whether a mode is a skip mode or an inter-prediction mode in which a motion vector is zero; and
determine a DCT size by repeating the DCT until the variance value does not exceed a determined threshold range if, as a result of the determination, it is determined that the mode is not the skip mode or the inter-prediction mode in which a motion vector is zero.

10. The apparatus of claim 9, wherein the DCT performance unit is further configured to:
determine whether a mode is a skip mode or an inter-prediction mode in which a motion vector is zero; and
determine a DCT size by repeating the DCT until the variance value does not exceed the determined threshold range if, as a result of the determination, it is determined the mode is the skip mode or the inter-prediction mode in which a motion vector is zero and also it is determined that the size of the CU is not equal to that in the previous image.

11. A method of determining a discrete cosine transform (DCT) size based on a transform depth, the method comprising:
a prediction mode determination step of determining, by a prediction mode determination unit, a prediction mode in order to determine a DCT size at a root location of a coding unit (CU) present in a coding tree unit (CTU);
a transform unit (TU) generation step of partitioning, by a TU generation unit, the CU into transform units (TUs) based on a residual quad tree (RQT); and
a DCT performance step of performing, by a DCT performance unit, DCT based on the TUs.

12. The method of claim 11, wherein the prediction mode determination step comprises determining any one of an intra-prediction mode and an inter-prediction mode depending on a similarity between a predicted image and an original image.

13. The method of claim 12, wherein the DCT performance step comprises calculating a first SAD value that is an SAD value corresponding to the RQT, with respect to an SAD value of the TU corresponding to a prediction mode determined at the prediction mode determination step.

14. The method of claim 13, wherein the DCT performance step comprises calculating a second SAD value which is an SAD value of a candidate prediction block corresponding to the predicted image after calculating the first SAD value.

15. The method of claim 14, wherein the DCT performance step comprises calculating a variance value within a quad tree based on a difference between the first SAD value and the second SAD value after calculating the second SAD value.

16. The method of claim 15, wherein the DCT performance step comprises comparing the variance value with a predetermined threshold range after calculating the variance value.

17. The method of claim 16, wherein the DCT performance step comprises:
increasing a DCT depth and performing DCT having a smaller size if the variance value exceeds the predetermined threshold range; and
determining a current DCT size to be a final size if the variance value does not exceed the predetermined threshold range.

18. The method of claim 11, wherein the DCT performance step comprises:
determining whether a mode is a skip mode or an inter-prediction mode in which a motion vector is zero; and
performing DCT using a DCT size corresponding to that in a previous image if, as a result of the determination, it is determined that the mode is the skip mode or the inter-prediction mode in which a motion vector is zero and also if a size of the CU is equal to that in the previous image.

19. The method of claim 18, wherein the DCT performance step comprises:
determining whether a mode is a skip mode or an inter-prediction mode in which a motion vector is zero; and
determining a DCT size by repeating the DCT until the variance value does not exceed a determined threshold range if, as a result of the determination, it is determined that the mode is not the skip mode or the inter-prediction mode in which a motion vector is zero.

20. The method of claim 19, wherein the DCT performance step comprises:
determining whether a mode is a skip mode or an inter-prediction mode in which a motion vector is zero; and
determining a DCT size by repeating the DCT until the variance value does not exceed the determined threshold range if, as a result of the determination, it is determined that the mode is the skip mode or the inter-prediction mode in which a motion vector is zero and it is determined that the size of the CU is not equal to that in the previous image.
